(19) United States
(12) Patent Application Publication
(10) Pub. No.: US 2004/0056546 A1
(43) Pub. Date: Mar. 25, 2004

(54) Magnetically-powered flywheel rotor motor

(76) Inventor: Gary L. Camm, Rockford, IL (US)

Correspondence Address: Gary L. Camm, 6371 Tramore Lane, Rockford, IL, 61107, US

(21) Appl. No.: 10/102,337

(22) Filed: Sep. 20, 2002

(51) Int. Cl. H02K 7/09

(52) U.S. Cl. 310/90.5

(57) ABSTRACT

An energy-developing apparatus for multiple power applications having a housing adaptable to various mountings with a single flywheel rotatable about a central axis shaft within the housing. The shaft is supported by permanent magnets mounted on both ends of the shaft with their matching halves permanently mounted in the housing. A rotatable flywheel is mounted in the center of the central axis shaft and is surrounded with a series of permanent magnets. Input energy is supplied by wire-wound permanent magnets connected to the housing for initiating and maintaining rotational stability of the flywheel. The central axis shaft also provides the output mechanism for converting the rotation of the flywheel into potential energy. This flywheel system is designed to be safe, adaptable and portable.

### CROSS-REFERENCE TO RELATED APPLICATIONS

Not applicable

### BACKGROUND

1. Field of Invention

This invention relates to magnetic motors and reciprocating engines.

2. Description of Prior Art

Reciprocating engines have powered automobiles, trucks, planes and generators has for roughly a hundred years. Their use has been taken to the extreme of reliability and durability. These engines are powered by burning organic fuel. However, environmental concerns and supply problems have created the need for alternative power supplies. Therefore, several types of magnetic motors have been created.

U.S. Pat. No. 4,196,365 to Presley (1980) discloses a magnetic motor that uses a rotary shaft and a rotating disc to produce torque. However, this invention depends on electrical solenoid coupled to a timing cam to forcefully displace the brackets, causing rotational force to the shaft. This system requires an external electrical source.

U.S. Pat. No. 4,517,477 issued to David P. Pankrats (1985) uses an electric timing device to cause rotation in the stator and can't be revolved without them.

Several patents like U.S. Pat. No. 5,448,116 (1995) use magnets to create torque energy for rotational movement, but all of the magnetic motors heretofore known suffer from a number of disadvantages:

(a) They all depend on some type of electrical energy to perform their function, making them dependent on heavy and bulky storage batteries or outside electrical sources.

(b) They are extremely bulky in size and don't lend themselves well to adaptations to a wide variety of applications. Some are not even containable in one package that could be made water proof or vapor proof, such as today's conventional motors can be.

(c) They would be expensive to manufacture and would require highly skilled maintenance upkeep. When you have so many delicate parts in one motor, the life span of the moveable parts must be cared for.

(d) They are not friction-free. Their own movement would start to wear themselves out.

(e) These motors have no advantage for using any form of kinetic energy. They have no flywheel to transfer energy.

### SUMMARY

My magnetic flywheel motor provides a magnetically-powered and positioned motor able to do work and cause no environmental problems.

### OBJECT AND ADVANTAGES

Several objects and advantages of my magnetic flywheel motor are:

(a) to provide a motor that uses no conventional fuel

(b) to provide a motor with only one (1) moveable part so wear and heat are kept at a minimum

(c) to provide a maintenance-free motor with no pollution problems to overcome

(d) to provide a light-weight durable motor that can be mounted in any position

(e) to provide a magnetic motor that is not dependent on an electrical source for bearing support

(f) to provide a motor that can be speed-controlled if necessary by the addition of one switch

(g) to provide a motor that can use kinetic energy for power

Still further objects and advantages will be apparent from a consideration of the ensuing description and drawings.

### DRAWING FIGURES

In the drawings, closely related figures have the same number, but different alphabetic suffixes.

FIGS. 1A and 1B show a tubular mainshaft.

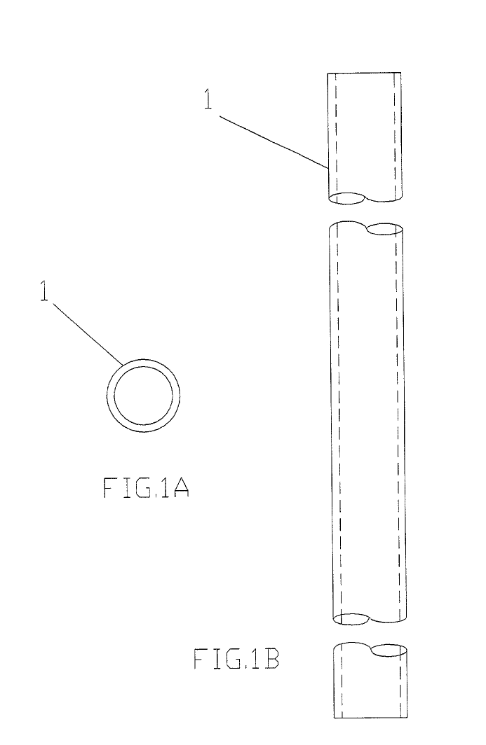

FIGS. 2A and 2B show a conical-shaped circular magnet with the plus side of magnet on the small end.

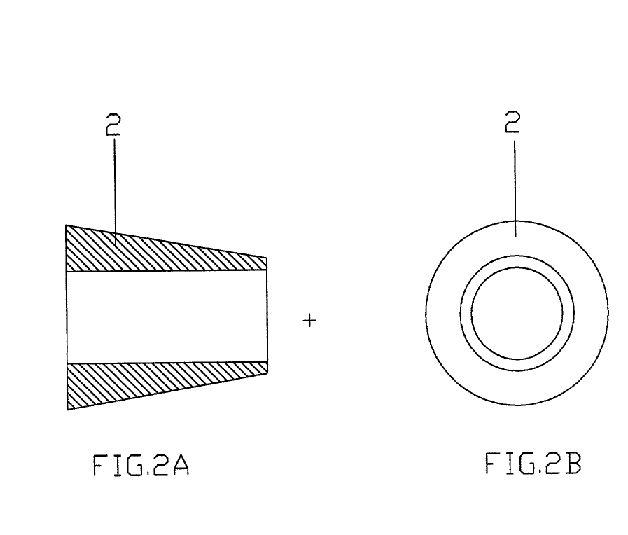

FIGS. 3A and 3B show a nonmagnetic flywheel.

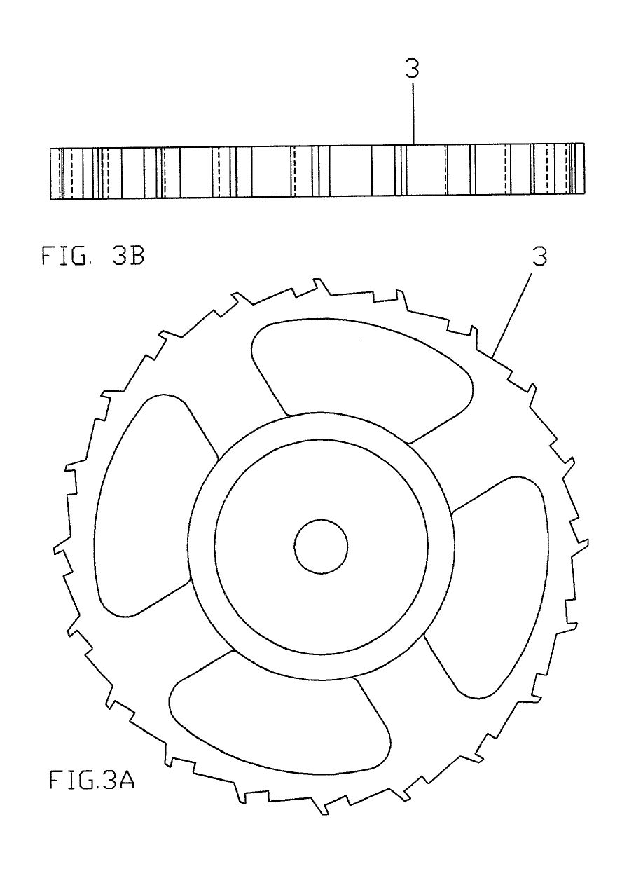

FIGS. 4A and 4B show a rectangular magnet with the positive side as the top face.

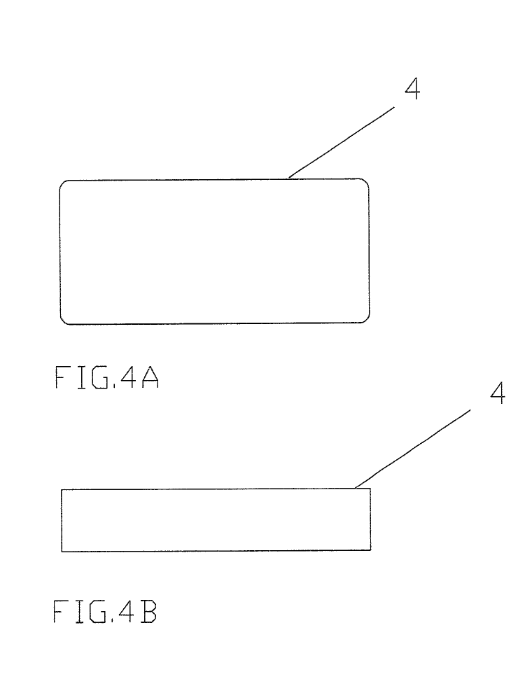

FIGS. 5A and 5B show segmented ring magnet with alternating positive and negative faces exposed.

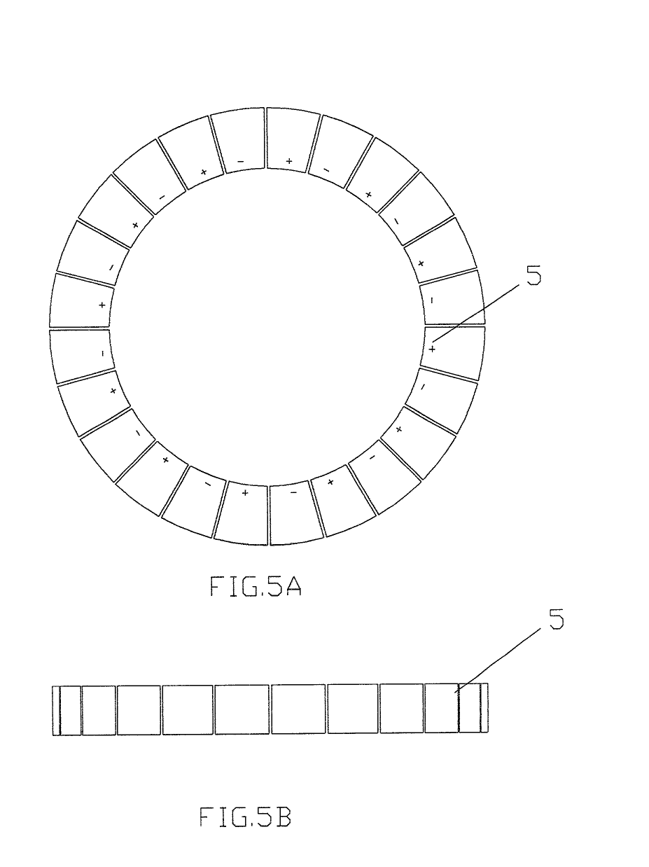

FIG. 6 shows the flywheel FIG. 3 with the segmented ring magnet FIG. 5 and the rectangular magnet FIG. 4 installed on the flywheel.

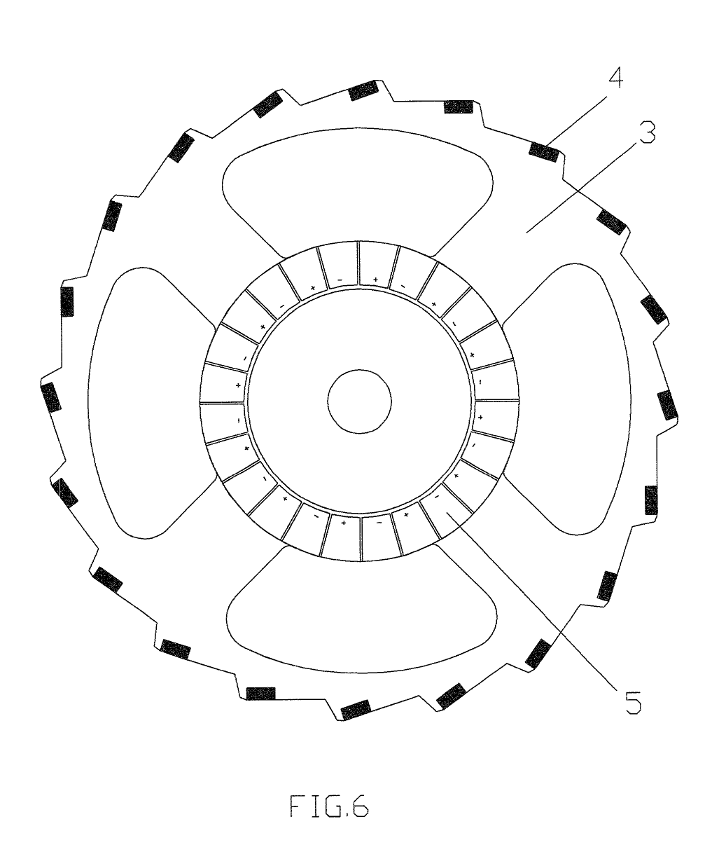

FIGS. 7A to 7C show the flywheel FIG. 6 and the magnets FIG. 2 installed on the tubular mainshaft FIG. 1.

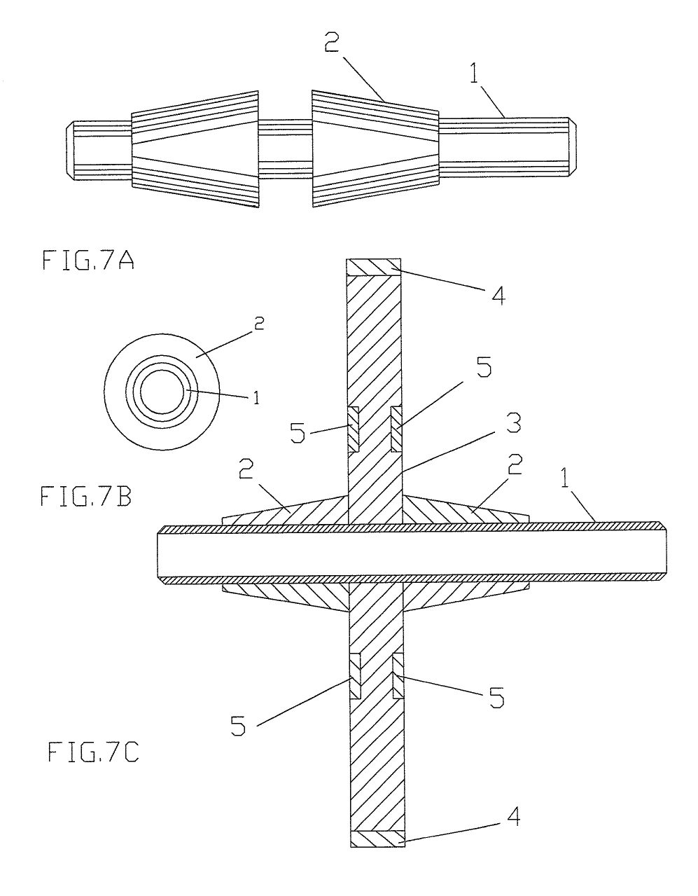

FIGS. 8A and 8B show a circular magnet with a conical-shaped circular interior having the larger end face negative.

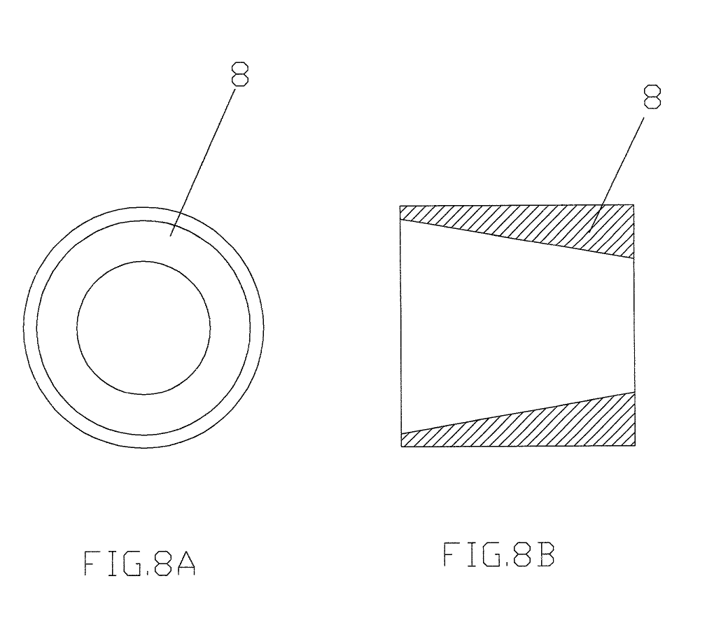

FIG. 9 shows a wired segmented ring magnet having all the negative poles wired together as well as all the positive wires wired together to form a magnetic coil.

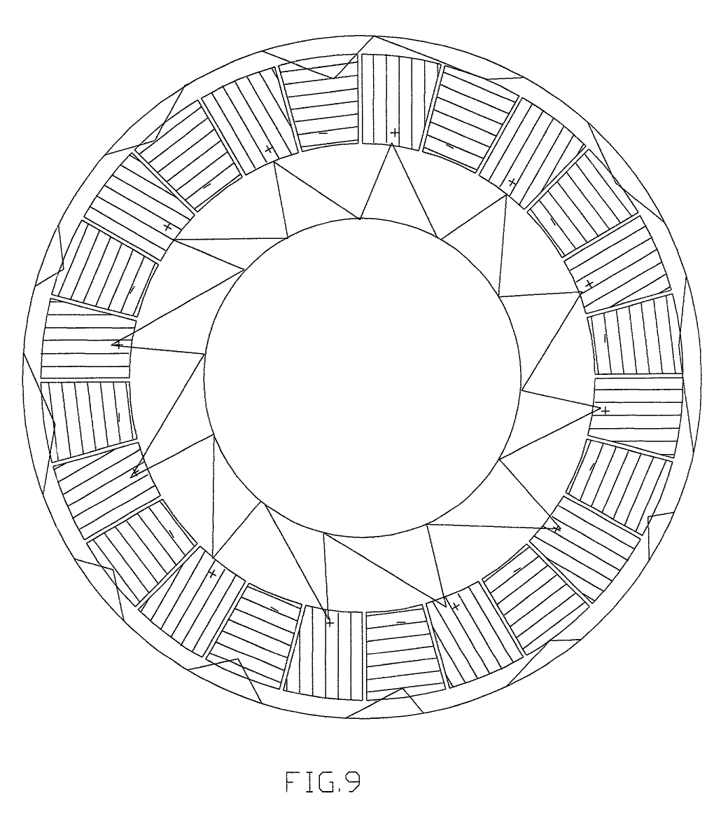

FIGS. 10A to 10C show a curved attachment bracket.

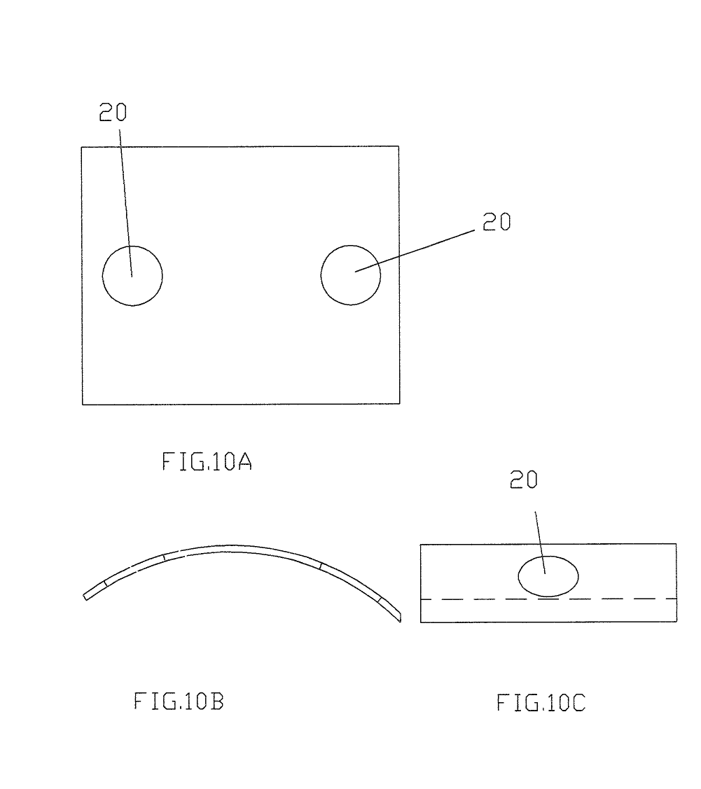

FIGS. 11A and 11B show a cast permanent magnet with magnetic wires installed attached to a circular mounting bracket FIG. 10.

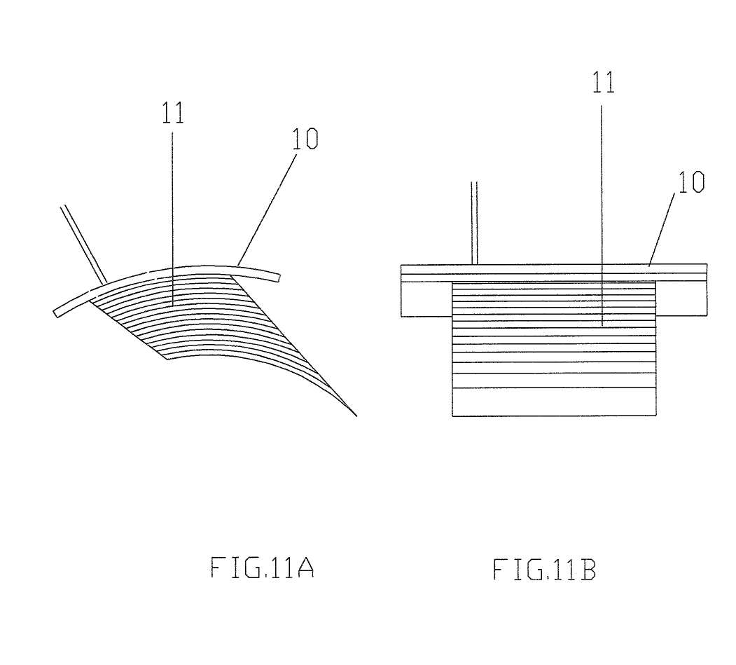

FIGS. 12A and 12B show one half of the main housing.

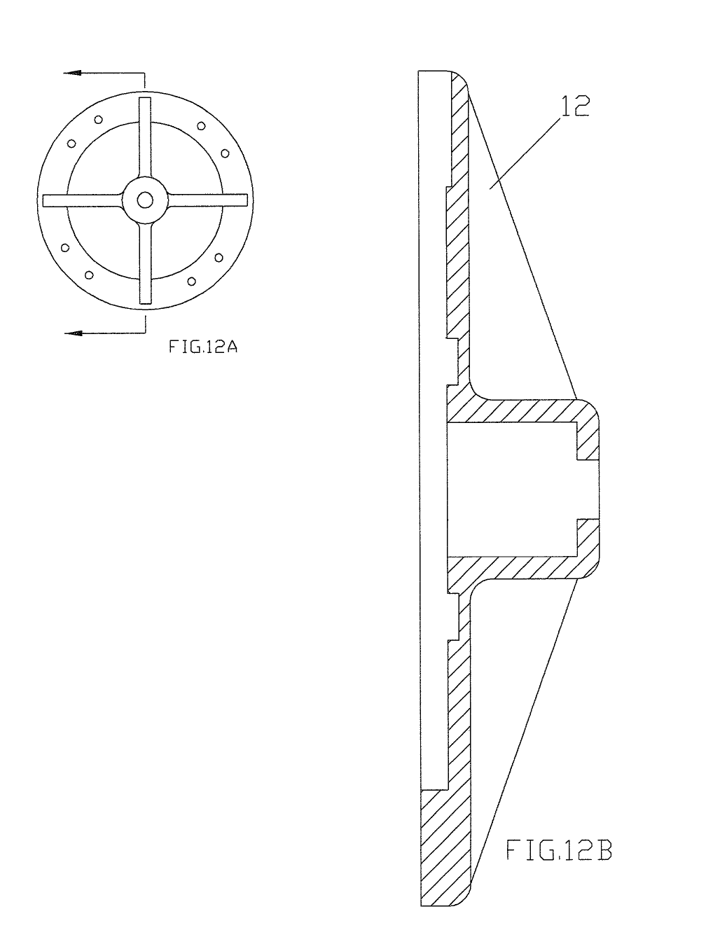

FIGS. 13A and 13B show the two housing halves with the segmented ring magnets FIG. 9 and the circular magnets FIG. 8 installed.

FIGS. 14A and 14B show a side view with FIGS. 1 thru 5 and FIGS. 8 to thru 12 installed in their proper operating positions.

FIG. 15 shows a front view with FIGS. 3 thru 12 installed in their proper operating positions.

FIG. 16 shows the same view as FIG. 15 with the exception that one half of the housing FIG. 12 is removed for clarity.

### REFERENCE NUMBERS IN DRAWINGS

1 shaft

2 inner magnet bearing

3 flywheel

4 outer flywheel magnet

5 segmented ring flywheel magnet

8 outer bearing magnets

9 segmented ring housing magnet

10 mounting bracket

11 power magnet

12 housing shell

20 hole

22 purchased capacitor

24 purchased speed control

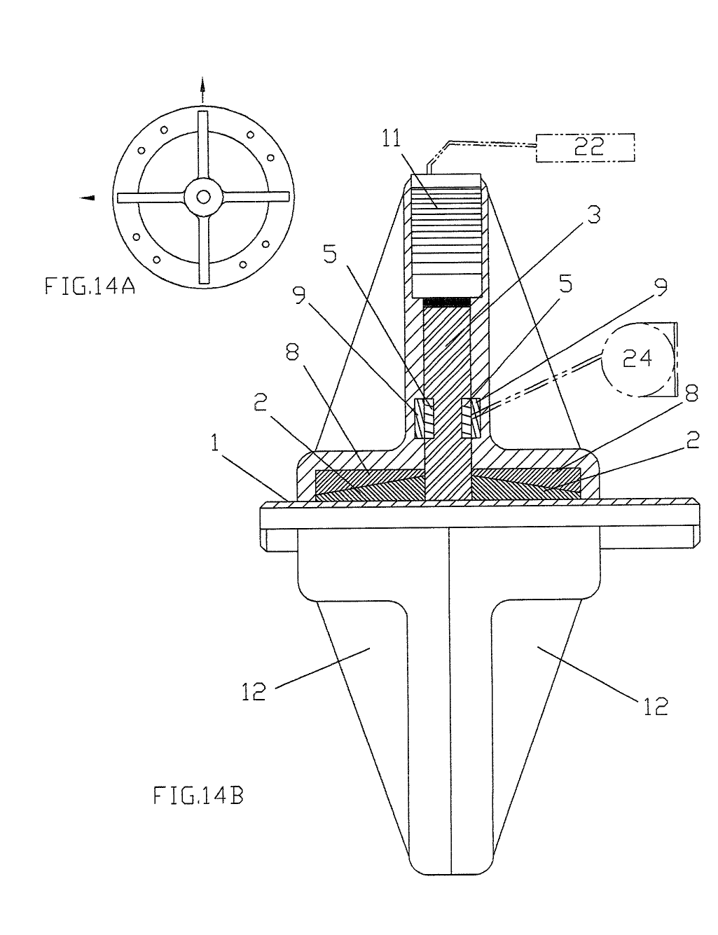

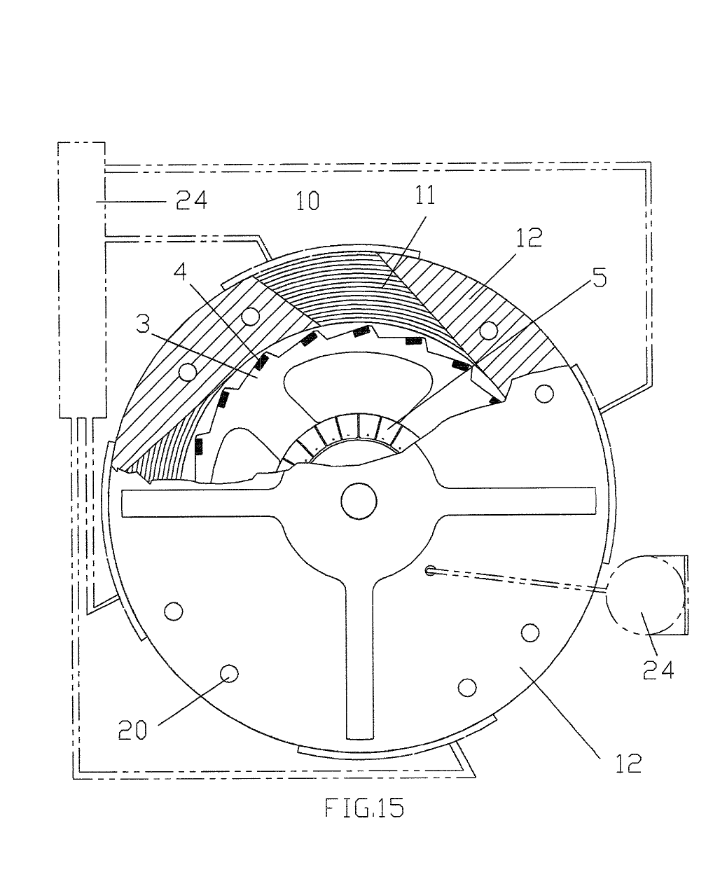

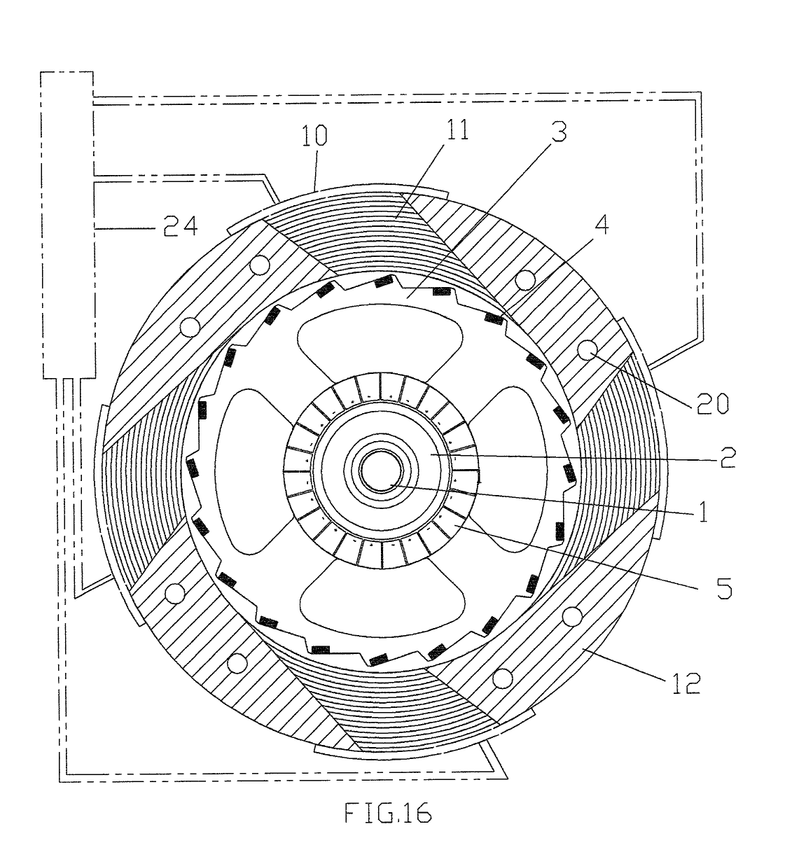

Description—FIGS. 14 to 16-Preferred Embodiment

A preferred embodiment of the motor of my magnetic flywheel motor is illustrated in FIG. 14 to FIG. 16 where the mainshaft 1 is held in position by the magnetic fields generated by inner bearing 2 and the outer magnetic bearings 8. The magnets are in attraction of each other. The rotational velocity is created by the repulsion of the flywheel magnets 4 by the cast housings power magnets 11. The flywheel ring magnets 5 and the housing ring magnets 9 generate electrical energy by the rotation of the flywheel 3. Control of the electrical power is by the capacitor 22. The speed is controlled by the speed control 24.

All magnets are secured to their respective surfaces by cyanoacrylate ester. The magnets are made of rare earth material.

Alternative Embodiments

The motor can be manufactured using plastic components such as the flywheel 3 and the outer housing 12. The magnets can be made from ceramic or alnico material. The magnets can be secured by screws if necessary. The side ring magnets 5 and 9 can be wired up so the both sides feed into one capacitor 22.

Advantages

A number of advantages of my magnetic flywheel motor are evident:

(a) The motor can be made of a wide variety of materials.

(b) The motor uses no conventional fuel.

(c) The motor uses no pollution-producing lubricant that would produce harmful hydrocarbons.

(d) It can be positioned in either a horizontal or vertical position without any danger of leakage of a polluting fluid.

(e) The motor generates more electrical energy than it uses.

(f) Only one side pair of the segmented ring magnets are used for energy. The other side can be used through the capacitor for household electrical power.

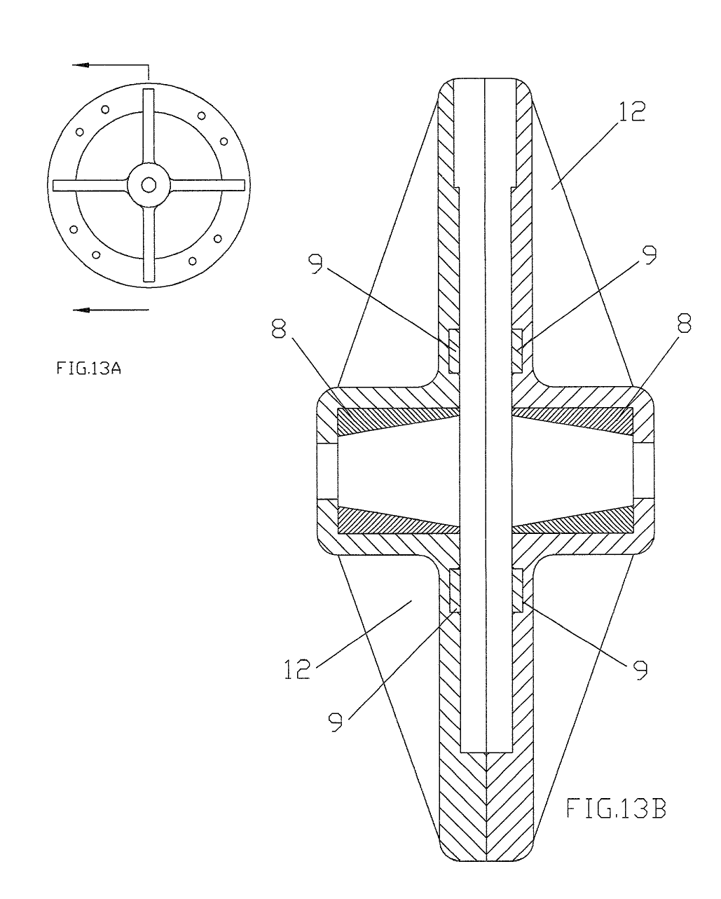

Operation—FIGS. 13A-16

My magnetic flywheel motor is operated by the turning of the mainshaft 1. The inner magnet 2 is secured to the shaft thus causing the mainshaft 1 to float inside the magnetic bearing. These bearing are aligned so that the positive and negative ends line up together, allowing the inner bearing 2 to suspend by the attraction of the two magnetic surfaces. The flywheel is turned by the repulsion of the magnetic fields between the flywheel rotor magnets 4 and the power magnets 11. To help avoid slow down when a load is applied to the motor, electrical energy is taken from one side pair ring magnets 5 and 9 and fed to the speed control 24 from the capacitor 22 adding extra power to the permanent power magnet 11.

Flywheel rotation causes kinetic energy to build up on mainshaft 1 that can be used to drive equipment such as an automobile or generator.

The motor would be shipped with the power magnets 11 removed, then replaced so the motor would be started at it's place of work.

### CONCLUSION, RAMIFICATIONS, AND SCOPE

My magnetically-powered flywheel rotor motor can be used to power an almost unlimited amount of mechanical devices without any outside power source. The motor has no limitations where it can be used, such as in an explosive vapor plant or an arid climate that has no conventional power source.

The construction is such that it can be made of aluminum or a polycarbonate material.

The halves are held together with simple bolt and nut assembly.

It can be assembled with little training

The motor has low maintenance

I claim:

1. A magnetically powered flywheel rotor motor comprising;
a) a flywheel rotor, said flywheel rotor having at least ten permanently magnetized elements attached to said flywheel rotor;
b) a shaft, said shaft being permanently bonded to rotor thru center of rotor in exact center of said shaft;
c) hollow cone shaped permanent magnets, said hollow cone shaped permanent magnets attaches to the outer edges of shaft;
d) a housing, said housing consisting of two halves joined together by bolts at their flanges;
e) cylinder shaped permanent magnets, said cylinder shaped permanent magnets permanently attached to recessess in each housing interior, and each cylinder shaped permanent magnet having a cone shaped interior that corresponds to permanently mounted cone shaped magnets on shaft ends forming a magnetic bearing when shaft, is mounted in housing;
f) Magnetic bearings, said magnetic bearings in attraction to each other levitate the shaft and rotor assembly;
g) Permanent magnets, said permanent magnets attached through slots in assembled housing cause rotor assembly to rotate due to magnetic repulsion of permanently attached magnets on rotor outside edge;
h) magnet wiring, said magnet wiring attached to housing power permanent magnets.

2. A magnetically powered flywheel rotor motor of claim 1 whereas the permanent magnets produce initial startup and running power the magnetly wired permanent power magnets allow the use of external solar cells for more consistent power supply.
